(19) United States
(12) Patent Application Publication
(10) Pub. No.: US 2004/0251063 A1
(43) Pub. Date: Dec. 16, 2004

(54) Modular mobility unit

(76) Inventors: Richard A. Patterson, Georgetown, TX (US); Alan D. Patterson, Austin, TX (US); Roy M. Patterson, Austin, TX (US); Joseph S. Skraba, Austin, TX (US)

Correspondence Address: Jack V. Musgrove, 2911 Briona Wood Lane, Austin, TX, 78613, US

(21) Appl. No.: 10/683,223

(22) Filed: Oct. 10, 2003

Related U.S. Application Data
(63) Continuation-in-part of application No. 10/460,602, filed on Jun. 12, 2003.

(51) Int. Cl. B60K 1/00

(52) U.S. Cl. 180/65.1

(57) ABSTRACT

A mobility unit uses several modular components that allow the unit to be assembled or re-configured into one of a number of different product designs. Four such modules may include a front module which houses the front pivoted casters or wheels and foot rests, a center module which provides the lifting/transfer/elevate functions, a propulsion module having the rear wheels, variable speed/reversible gear drive motors, batteries, and a chair control computer, and a rear module which contains the seat back cushion and support, and any push handles and controls for operation by an caregiver. Mechanical interfaces are designed to accommodate the interconnection of the modules in various configurations. Advantageously, the central lifting module is adapted to function in either a right-hand orientation or a left-hand orientation. The versatility and functionality of the modular mobility unit enables one basic modular product platform to be configured as a large number of different individual products, each with specific capabilities and each upgradeable or field re-configurable to other products. These products can vary not only with regard to the handedness of the chair, but additionally with regard to other features.

### CROSS-REFERENCE TO RELATED APPLICATION

This application is a continuation-in-part of U.S. patent application Ser. No. 10/460,602 filed on Jun. 12, 2003, which is hereby incorporated.

### BACKGROUND OF THE INVENTION

1. Field of the Invention

The present invention generally relates to mobility enhancement systems for physically challenged individuals, and more particularly to wheelchairs which allow the user to be elevated or transferred to a position adjacent the wheelchair, and modular constructions for wheelchairs.

2. Description of the Related Art

In the United States alone, there are over three million physically challenged individuals who are confined to wheelchairs due to illness, accidents or degenerative diseases. While about half of these people are able to stand on their own, the remaining half are unable to support their weight on their legs. Approximately 80% of people using wheelchairs are cared for in their own homes, while the remainder are cared for in nursing homes, hospice facilities, rehabilitation centers and hospitals.

Handicapped people who are unable to stand or otherwise lift their weight with their arms face many difficulties in their daily lives. One of the most serious of these is that they must be frequently lifted and transferred between their wheelchairs and their beds, regular chairs, dining facilities, bathroom fixtures, cars, etc. In nursing homes for example, it is estimated that patients must be lifted and transferred 10 to 15 times per day depending on their illness and physical condition.

Lifting and moving these individuals usually is done by family members, friends or professional care givers in home care situations, and by trained nurses or therapists in institutional settings. Occasionally, commercially available lifting aids are employed to assist with patient lifting, but because of limitations and ease of use issues, most patient lifting and transfers are done manually. Whenever disabled individuals are lifted or moved, there is a possibility for injuring that person. These injuries usually result when the patient is bumped into objects while being lifted and transferred, or from being dropped.

When caregivers manually lift and transfer patients, they can seriously injure their backs. Often the patient being lifted is significantly heavier than the care giver, and cannot assist the care giver during the move. Some patients also move erratically while being moved, and may slip out of the care givers grasp, or force the care giver to quickly readjust their lifting position. Lifting and moving patients is, however, part of the expected activities for nurses and caregivers. If they are unable to perform these functions due to lifting injuries to the back, they may be required to work in other capacities in the health care system, or to find other jobs. The loss of skilled experienced nurses and care givers in nursing homes, hospitals, and hospice institutions reduces the overall quality of healthcare delivered.

In nursing homes in some states, formal reports must be written each time a patient is injured no matter what the reason. These reports are then reviewed with the nursing home management and corrective action is taken. The reporting process and subsequent review sessions, although worthwhile, result in significant additional effort and cost on the part of the nursing institution. In home care settings, a significant portion of the cost of caring for a seriously handicapped individual is the cost of care givers who are required to safely lift and move the patient. Providing an alternative means for lifting and transferring the patient would then enable family members or friends to provide for more of the patient's healthcare needs. This could reduce the cost of in home patient care over extended periods of time.

Another problem confronted by people with serious physical disabilities is the occurrence of pressure or bed sores when the patient is allowed to remain in one position for extended periods of time. Pressure sores are painful and very difficult and expensive to cure. A system that made it easier for patients to be moved could increase the frequency of patient moves, and reduce the occurrence of pressure sores.

Many individuals who are seriously handicapped due to accidents or illness were active, self supporting people prior to the onset of their handicap. It is often difficult for challenged people to make the transition from being totally independent, to being highly or totally dependent on caregivers for the most basic functions. Handicapped individuals must deal with the pain and suffering associated with their illness on a day to day basis. At the same time, they also face the loss of independence and self sufficiency that they once enjoyed. The combination of these two factors can lead to the onset of serious depression in the individual, and thus reduce the rate of their recovery. Providing a means to enable the handicapped individual to be more self sufficient, and more independent, could significantly enhance the individuals quality of life, reduce their dependence on professional caregivers, and thus reduce the cost of care for that person.

There are several mechanized patient lift and transfer systems currently being sold for handicapped individuals and their care givers. However, these devices and systems have serious short comings, and do not address the total need associated with safely lifting, transferring, and transporting handicapped individuals within their daily living and healthcare environments. One device commonly used is a hydraulically operated hoist or crane in which the patient is supported in a flexible sling. This device consists of a pivoted arm mounted to a base containing casters. The arm is moved by a hydraulic cylinder, and the patient lifting sling is attached to the end of the arm with a lifting bridle and chain.

The hydraulic patient lift is operated by a care giver, and not by the patient. The device is normally located next to a bed, or in a bathroom, and is used to lift the patient from bed to a wheelchair and back, or from a wheelchair to a bathroom or bath fixture and back. It does not go with the patient as the patient moves between rooms and certainly does not go not outside of buildings.

These lifting/hoist devices are normally equipped with casters. Although it would be possible to move the patient hoist between lifting locations, these types of lifting devices are awkward to move, and are designed primarily for use in one location. Thus for a patient being lifted in multiple rooms, it would be most convenient to have one lifting system for each location where a patient might need to be lifted and transferred. The devices are relative large, and take a considerable amount of floor space.

Since the lifting device is outfitted with casters, it would also be possible to move the patient between rooms while hanging from the end of the hoist. However this can be demoralizing and degrading for patients to be dangling from the end of a chain in a sling while being moved in public places, and this form of patient transport is normally not done.

Another significant disadvantage of hoist devices is that the lift starting position, patient's trajectory or path during the move, uniformity of motion, and end landing position are all controlled manually by the care giver. Even if the care giver is well-trained, it is relatively easy for the care giver to cause the patient to collide with stationary objects during lifts and transfers, and even drop the patient at the end of the move.

One final disadvantage of lifting hoists is that they are not designed so the user cannot operate the hoist themselves. Thus, handicapped individuals who are seeking greater independence from caregivers still will require another person to operate the lifting hoist style patient transfer device.

Another patient lift and transfer system is available for use in homes and institutional settings, referred to as an overhead hoist/trolley system, which also has significant limitations and drawbacks. It consists of a set of tracks that are permanently attached to the ceiling of rooms in a home or institution. A trolley rides on the track that contains an electrically powered chain hoist. The track is located on the ceiling directly above the patient's bed and possibly above a chair in a bed room for example. Separate sections of track can also be installed on the ceiling in hallways, bathrooms, kitchens, etc. Each section of track in each room contains its own separate trolley device with lifting hoist.

With such a system, the patient is lifted in a sling or rigid harness that connects to a hook at the bottom of the lifting hoist. This lifting hoist is attached to and supported by the trolley riding on the overhead track. After the patient is lifted by the hoist and their weight is supported on the trolley, the trolley can be moved away for the lifting position toward a second target position such as a wheelchair. The system is capable of moving a patient from bed to a wheelchair for example, but since the overhead track is not continuous with other rooms (due to dropped headers above doors), the patient must use a different lifting hoist and track section to be lifted from the wheelchair in another room. This means that the patients lifting sling must be disconnected and reconnected to the lifting hoist in each new room where a patient transfer is required. It is clearly not possible to transfer a patient in any indoor or outdoor location where the overhead lifting track is not in place. Accordingly, the overhead track system could not be used for transferring a patient from his wheelchair into a car for example.

Another limitation of the track patient lift system relates to installation of the system in a home or institution. The lifting system and patient can weigh up to 400 lbs, which may require reinforcement of the ceiling to which the tracks are attached. Each section of track must contain its own lifting trolley and hoist since tracks cannot pass under door headers in adjacent rooms. Finally, like floor model hydraulic lifting hoists, the overhead system depends on the training and dexterity of the care giver to move the patient smoothly and safely. There are opportunities for patients to be bumped and dropped with this system since the lifting path and end target are established manually.

Other devices are also coming into the market that enhance a patient's mobility and independence. These devices are referred to as “standers”, and they enable a user or individual who is seated to be able to rise to a standing position. They do not however enable a patient to be lifted and transferred between wheelchairs, furniture, cars, and the like.

Another problem with mobility devices that are available today is that there is no single device that can provide all the major mobility functions required by handicapped persons. These mobility needs include (i) transporting (moving about inside and outside the residence), (ii) raising to reach elevated objects, and (iii) lift and transferring to and from the mobility device. Powered wheelchairs can transport a person in and outside his residence but cannot lift and transfer the person. Lifts can lift and transfer a person to and from his wheel chair, but cannot transport him within his residence.

There is a further problem with the “handedness” of some mobility systems, i.e., they are constructed with an asymmetrical design which allows elevating or transferring to only one side of the wheelchair. For example, any transfer chair that would be designed to move a user into the driver's seat of a car would be right-handed, that is, it could transfer the patient to the right side of the chair, but not to the left side. Such a construction may present difficulties when the user is in a setting which requires elevation or transfer to the left side. Alternatively, the user may be forced to rearrange his or her living quarters or workspace in order to accommodate the handedness of the wheelchair. Current mobility systems are not versatile enough to allow deployment on either side. To assure that a system has been properly “fitted” to the individual's needs, it would be necessary for the installer of the new chair system to survey the person's residence or office, and determine whether the “right-hand” or “left-hand” version of the chair would satisfy most of the person's transfer needs.

If a right-hand lift/transfer/elevate chair system had been recommended and installed to meet a person's living needs, but those needs change in the future due to moving or a change in physical capabilities, it might be more convenient for this person to later use a left-handed transfer chair. Unfortunately, current transfer chairs do not allow for either factory or field conversion from right-hand lifting capability to left-hand. It would therefore be necessary for the individual to obtain a new left-handed chair.

The handedness of a transfer chair can additionally create problems with regard to the manufacturability of the chair. It would be necessary for a manufacturer to separately fabricate both right- and left-hand chairs from different lots of parts including separate chair chassis, lifting arms, etc., for the right-hand and left-hand versions of the chair. Although separate parts can be provided, it increases the amount of engineering required for design of the chair, and also increases the amount of inventory of separate types of parts that the manufacturer must maintain in stock to provide both right- and left-hand chairs against orders.

A final problem with mobility devices that exist today is that they cannot be upgraded to meet the mobility needs of their users as these needs change. Powered wheelchairs for example cannot be modified or upgraded to provide lift and transfer capability as the user becomes less able to move himself. Usually it is necessary for the handicapped person to purchase additional separate pieces of equipment, and/or to rely more heavily on caregivers which substantially increases the cost of care.

In light of the foregoing, it would be desirable to devise an improved mobility system for physically challenged individuals which allows the user to be transferred to a position adjacent the wheelchair, without all of the limitations and drawbacks of the foregoing devices. It would be further advantageous if a single mobility system could provide for all of the handicapped person's major mobility needs, could be easily configured to allow either right-hand or left-hand use, and could be easily be upgraded to meet the handicapped person's mobility needs as these needs change in the future.

### SUMMARY OF THE INVENTION

It is therefore one object of the present invention to provide an improved system for easily, safely, and precisely lifting and transferring individuals between their wheelchairs, and their beds, other chairs, bathroom fixtures, cars, etc.

It is another object of the present invention to provide such a system which can be deployed for either right-hand or left-hand use.

It is yet another object of the present invention to provide a modular mobility unit which simplifies manufacturing concerns with regard to the handedness of the unit.

It is yet another object of the present invention to provide a modular mobility unit in which any single module may have several unrelated functions.

The foregoing objects are achieved in a mobility unit which uses several modular components that allow the unit to be assembled or re-configured into one of a number of different product designs. In the illustrative embodiment there are four such modules, including (i) a front module which houses the front pivoted casters or wheels and foot rests, (ii) a center module which provides the lifting/transfer/elevate functions, (iii) a propulsion module having the rear wheels, variable speed/reversible gear drive motors, batteries, and a chair control computer, and (iv) a rear module which contains the seat back cushion and support, and any optional push handles and controls for operation by an caregiver. Mechanical interfaces are designed to accommodate the interconnection of the modules in various configurations.

The center module preferably has a cubic volume, and is constructed to contain a mounting interface on the front surface of its volume that is essentially parallel to and spaced apart from a mounting interface on the rear surface of its volume. The region between the front and rear mounting interfaces of the center module may contain any one of the following functional elements. The region may serve merely as a mechanical spacer, and may contain only the mechanical structure necessary to maintain spacing, location and mounting relationships of modules attached to its front and rear interfaces. Alternatively, the region between the mounting interfaces on the center module may contain a symmetrical lift and transfer mechanism capable of lifting and transferring its user to the right or left of the module once assembled in the modular mobility unit. As a further alternative, the region between the mounting interfaces of the center module may contain a mechanism for raising the user's seat to enable him to reach elevated objects. Finally, the center module may contain electric drive motors and center mount drive wheels to enable the modular mobility unit to have center wheel drive feature.

Advantageously, when the center module contains a lift and transfer mechanism, it is constructed with the center of operation of the lifting arm equidistant between the front and rear mounting surfaces of that module such that the center section of the chair can be assembled in either a right-hand or left-hand manner. Thus, if an individual's living needs change and it becomes necessary to alter the handedness of the lift/transfer/elevate chair, this change can easily be implemented by a service technician. This approach similarly allows the modular mobility unit to be assembled in a manufacturing facility for use as either right- or left-hand operation against any customer orders. The versatility and functionality of the modular mobility unit enables one basic modular product platform to be configured as a large number of different individual products, each with specific capabilities and each upgradeable or field re-configurable to other products. These products can vary not only with regard to the handedness of the chair, but additionally with regard to other features. If the user purchased a modular mobility system in which the center module was only a spacer and seat support to meet his current needs for transport only and at some point in the future this person's condition changes and he is now unable to manually lift and transfer himself from his transporter unit into his furniture or bed, then the modular mobility system that he initially purchased could be easily upgraded by a technician in the handicapped person's home. The blank center section of the original unit is removed at its mounting interfaces, and a center module containing a lift and transfer arm and docking station is put in its place. All of the other modules of the original transporter unit could still be used. The field upgrade would now provide the handicapped person with a single mobility system that could transport him in and outside his residence, raise him to reach elevated objects, and lift and transfer him to and from his transporter unit. The cost to the insurer of utilizing much of the handicapped person's original transporter device, and only upgrading it to have lift and transfer capability it expected to be a much more cost effective way to quickly meet the handicapped person's changing mobility needs.

The above as well as additional objectives, features, and advantages of the present invention will become apparent in the following detailed written description.

### BRIEF DESCRIPTION OF THE DRAWINGS

The present invention may be better understood, and its numerous objects, features, and advantages made apparent to those skilled in the art by referencing the accompanying drawings.

FIG. 1 is a front side elevational view of one embodiment of a lift and transfer chair constructed in accordance with the present invention;

FIG. 2 is a right side elevational view of a further embodiment of a lift and transfer chair constructed in accordance with the present invention which utilizes modular components that allow the chair to be assembled (or re-assembled) to provide a number of different mobility unit functions and either right-hand or left-hand use;

FIG. 3 is a perspective view of one embodiment of a central module having a lift and transfer arm;

FIG. 4 is a front side elevational view of the chair of FIG. 2 illustrating a first style interface provided on opposite sides of the center module which is used to interconnect the center module with front and rear modules;

FIG. 5 is a top plan view of the rear portion of the chair of FIG. 2 depicting a second style interface provided on an upper surface of a rear module which is used to interconnect the rear module to a seatback/caregiver control module;

FIG. 6 is a perspective view of the lift and transfer arm seen in FIG. 3 showing how the lifting bridle rotates to allow different transfer configurations; and

FIG. 7 is a right side elevational view of an alternative center module have a central drive wheels.

The use of the same reference symbols in different drawings indicates similar or identical items.

### DESCRIPTION OF THE PREFERRED EMBODIMENT(S)

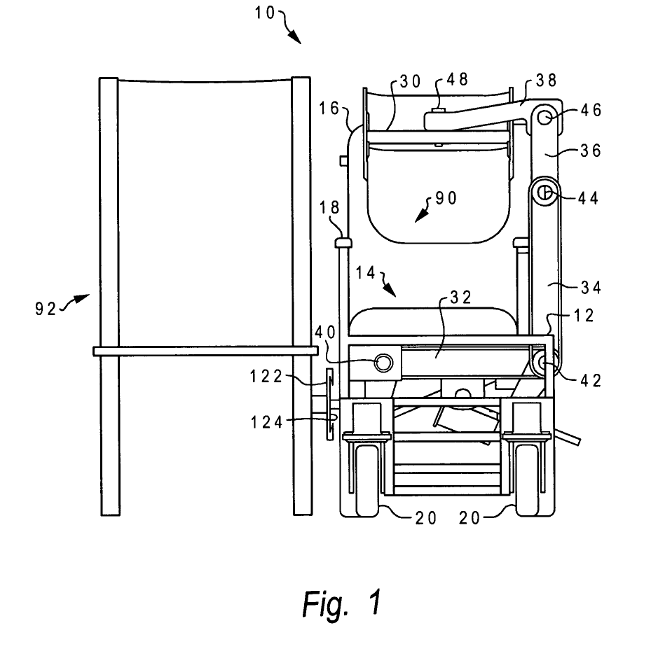

With reference now to the figures, and in particular with reference to FIG. 1, there is depicted one embodiment 10 of a lift and transfer chair constructed in accordance with the present invention. Lift transfer chair 10 is generally comprised of a chassis or frame 12, a seat 14 attached to frame 12, a chair back 16 attached to frame 12, arm rests 18 attached to frame 12, and wheels 20 operably mounted to frame 12. The outside of the chair chassis is covered by panels for the user's safety, and for protection of and access to internal components. In the illustrative embodiment, the lift transfer chair is designed to fit through a 24 inch door opening, and has the same approximate outside dimensions as currently available electric wheelchairs (23.5 inches wide×30 inches long×36 inches high). This embodiment has an electric drive (i.e., motor and gears) to impel chair 10 so wheels 20 are relatively small, but a manual drive version can be designed with larger rear wheels which the user physically pushes.

The lift mechanism of lift transfer chair 10 generally includes a lifting bridle 30, a series of arm links 32, 34, 36, 38, and one or more drive mechanisms coupled to frame 12. The four links 32, 34, 36, 38 are connected end-to-end through single-axis pivot pin joints, and provide an articulated path for the lifting bridle between a home position proximate the seat of chair 10 and a target position 92 adjacent to one side of chair 10. Link 32 has one end attached to chassis 12 at pivot pin 40, and the other end attached to one end of link 34 at pivot pin 42. The other end of link 34 is attached to one end of link 36 at pivot pin 44. The other end of link 36 is attached to one end of link 38 through pivot pin 46. The axes of pivot pins 40, 42, 44 and 46 are each perpendicular to the longitudinal axes of each of the links 32, 34, 36 and 38. The distal end of link 38 is attached to a foldable user lifting seat bridle 30 at pivot pin 48, whose axis is perpendicular to the axes of pivot pins 40, 42, 44 and 46. The axes of pivot pins 40, 42, 44 and 46 are always parallel to one another during operation of the lifting arm assembly. While the lift mechanism could be manually powered using, e.g., hand cranks, the preferred embodiment uses an electric drive. The lift mechanism may be controlled electronically.

During deployment of the lift mechanism, link 32 is caused to rotate through an arc of approximately 100 degrees about pivot pin 40 and with respect to the chair chassis by a first motor-operated lead-screw actuator. Link 34 is caused to rotate through an arc of approximately 90 degrees about pivot pin 42 and with respect to link 32 by a second motor-operated lead-screw actuator. In their stowed storage or home positions, the axis of link 32 is oriented approximately at a 30 degree angle to horizontal with its first end above its second end, and link 34 is oriented generally vertically. The two lead-screw drive actuator units are generally identical, and each has a 1 inch diameter, 10-pitch lead screw. The drive motors are mounted to thrust blocks with adjustable brackets and rotate the lead screws through a sprocket/chain drive.

Link 38 and its attached lifting bridle 30 are allowed to rotate with respect to link 36 between two stop positions. The first stop position is utilized when the lifting arm is deployed, i.e., lifting and transferring a user from the chair to a target position. The second stop position is used when link 36 and 38 are stowed inside the chair. Links 36, 38 and the lifting bridle 30 form a link assembly that is always maintained in a constant (the same) angular orientation with respect to the chair frame no matter what the angular orientation of links 32 and 34, due to the following construction. Pivot pin 44 is rigidly attached to the first end of link 36, and pivots in the second end of link 34. A 50-pitch 17-tooth sprocket is also rigidly attached to pivot pin 42 on the opposite side of link 34 from link 36. This sprocket is connected by a chain loop to the first plate of a double 50-pitch, 17-tooth sprocket that is supported on bushings on pivot pin 42. The second plate of the double sprocket is connected to a chain loop to another 50-pitch, 17-tooth sprocket that is supported on bushings on pivot pin 40. This sprocket is rigidly attached to a 5.5 inch diameter drive gear. The drive gear contains a projection on one side that contacts an adjustment screw that prevents the gear from rotating more than 240 degrees with respect to a fixed stop point on the chair chassis. A 1 inch diameter pinion gear also engages the 5.5 inch gear and causes it to rotate up to 240 degrees between stop positions. The drive pinion is rotated through a sprocket and chain drive arrangement by a right angle DC gear motor that is mounted to the chassis of the chair.

When the arm is in its lifting position, link 36 is generally vertical and link 38 is generally horizontal with the lifting connection bridle located under link 38. The projection on one side of the 5.5 inch diameter drive gear is in contact with the chair chassis stop, and is prevented from rotating. Since the sprockets on pivot pins 42 and 44 are chain connected to the 5.5 inch drive gear through the sprocket that is attached to the gear, the rotational orientation of the links 36, 38, and bridle assembly 30 is all controlled by the angular orientation of the drive gear. When the gear is rotated by its drive motor, and links 32 and 34 are held fixed by their lead screw drive actuators 50, 52, the link 36, 38 assembly will rotate about the second end of link 34. However, when link 32 is rotated with respect to the chair chassis and link 34 is rotated with respect to link 32, and the 5.5 inch drive gear is held fixed with respect to the chair chassis, the links 36, 38 will remain in the same angular orientation as the chair frame no matter where the second end of link 34 is positioned in space.

When link 38 is in its normal lifting (deployed) position, and the 5.5 inch drive gear is against its stop on the chair chassis, link 38 is generally horizontal, and link 36 is generally perpendicular to the floor. No matter where links 32 and 34 are rotated, link 38 will remain horizontal during deployment, and link 36 will remain vertical. The articulated path of the lifting arm preferably defines a clearance height of no more than about 42 inches. This limited clearance allows the user to be transferred through a car door opening into a vehicle without interference. When the links are not being used and are to be stored in the side of the chair under the arm rest, link 38 is rotated away from its lifting stop position, and to a storage stop that is 90 degrees from the lifting stop position. In this storage or stowed position, the axes of links 36 and 38 are generally aligned, with link 38 projecting straight beyond link 36. Rotation of link 38 and lifting bridle 30 is performed manually by the user or caregiver after the user is seated in the chair's transfer seat 90. With links 32 and 34 held fixed in their normal home position inside the base and arm of the chair, the 5.5 inch drive gear can be rotated approximately 180 degrees. This rotation causes links 36 and 38 to rotate with respect to link 34 to the storage position that is along side of link 34, and under the arm rest 18 of chair 10.

A docking station system contains a female receiver portion 122 that is permanently attached to the frame of the car (or chair, bed, etc.), and located along the side of the target opposite from the side in which upper portion of the lifting arm is stored on chair 10. In the illustrated construction, female receiver portion 122 comprises a socket or slot that is formed using a steel members. A male plug portion 124 integrated with chair 10 may take the form of a steel plate which then slides into female receiver 122. With this arrangement, the chair can be docked either by moving forward adjacent the target, or by moving backward adjacent the target depending on the most favorable layout of the user's living quarters or other environment.

Additional details for the lifting mechanism, electronic control system and docking station can be found in U.S. patent application Ser. No. 10/460,602 which is hereby incorporated.

Lift and transfer chair 10 allows the user to be transferred to only one side, e.g., to the right side in the depicted embodiment. However, in another embodiment of the present invention, the chair is constructed with modular, removable components. This design feature allows the chair to be easily assembled (or re-assembled) for either right-hand or left-hand use. Additionally, similar modules having different internal functions can be assembled at common interfaces to provide an entire family of mobility unit products that can transport its user, transport and raise its user, or transport, raise, and transfer/lift its user. This modular design improvement overcomes the shortcomings in embodiment 10 related to the chair's “handedness,” as well as enabling a family of mobility devices to be created by selection and assembly of specific module types, and providing for future function upgrading.

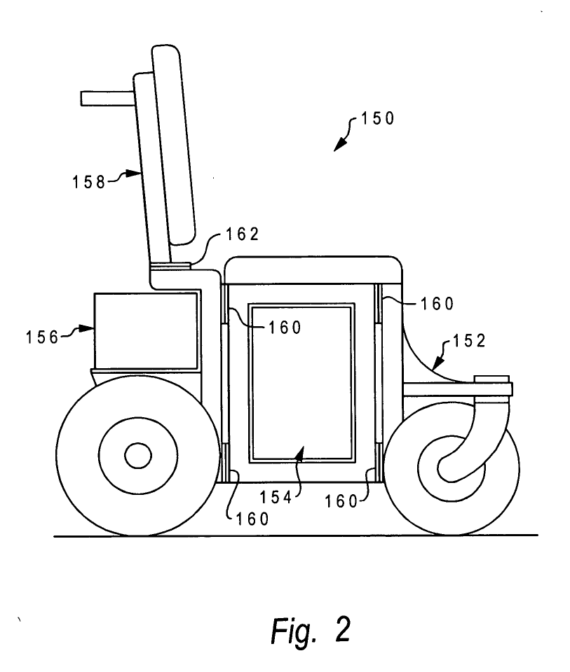

In a further illustrative embodiment, the increased versatility for the lift/transfer/elevate chair is achieved by dividing the chair into four different functional modules. These modules attach to one another at mechanical interfaces having known mounting and locating features. As shown in FIG. 2, this modular mobility unit 150 includes a front module 152, a center module 154, a rear module 156, and a seatback module 158. While these modules may be attached to a chair chassis, in the preferred embodiment the structural supports for the modules themselves become the chair chassis or frame.

Front module 152 contains the front pivoted casters or wheels, foot rests, and a sub-frame for attaching these elements to the center section of the chair. The sub-frame of front module 152 contains a first style of mounting interface 160 that enables it to be easily attached to the adjacent or center module of the chair.

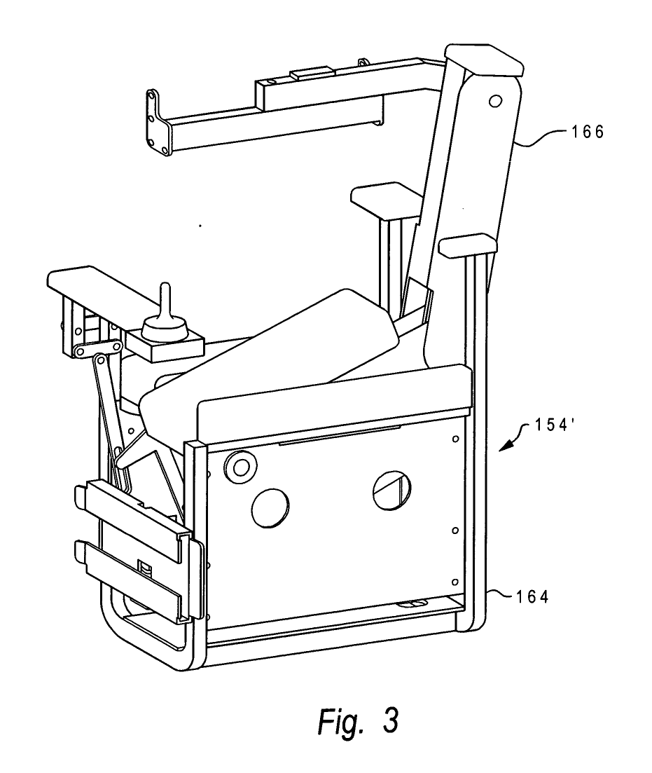

Center module 154 can provide a variety of functions including (i) being a passive structural member for a transport-only mobility unit, (ii) containing drive motors and actuators for raising the user's seat to reach elevated objects, and (iii) providing lift and transfer capability through a integral robotic lift/transfer arm mechanism. For each of these functions, the center module utilizes a sub-frame, with opposite sides of the sub-frame having mounting means for attaching the adjacent front and drive modules. In the case of a lift/transfer module, it provides the lifting/transfer/elevate functions. As shown in FIG. 3, this lift/transfer center module 154′ has the lift and transfer arm, lifting bridle and actuators for moving the arm linkages all contained within and attached to this sub-frame 164. The lifting arm 166 and one of its actuators are attached to the center of sub-frame 164 at pivot pins, and the lifting arm's transverse centerline of operation is located at the center of sub-frame 164. Center module 154′ also contains the docking station mechanism 124 that is located on the same side of the sub-frame that the lifting arm transfers toward. Thus, a chair that transfers its occupant to the right (as seen by the occupant looking forward when in the chair) would have its docking station on the right side of the sub-frame, and a chair that transfers its occupant to the left would have its docking station on the left side of the sub-frame. The sub-frame for the center module contains an identical first style mounting interface 160 on its front and rear sides (located 90 degrees from the docking station side of the sub-frame). The front side of this sub-frame attaches to front module 152, and the rear side of the center sub-frame attaches to rear module 156.

Rear module 156 may contain the rear wheels, variable speed/reversible gear drive motors, batteries, and the chair control computer. All these components are attached to a sub-frame that has two different mounting interfaces. The first interface surface is generally vertical and is on the front side of rear module 156, identical to the first style interface 160, and enables rear module 156 to be attached to center module 154. The second interface surface is generally horizontal and provides a second style interface 162 for mounting seatback module 158.

Seatback module 158 contains the seat back cushion and support, and any push handles and/or controls for operation by a caregiver.

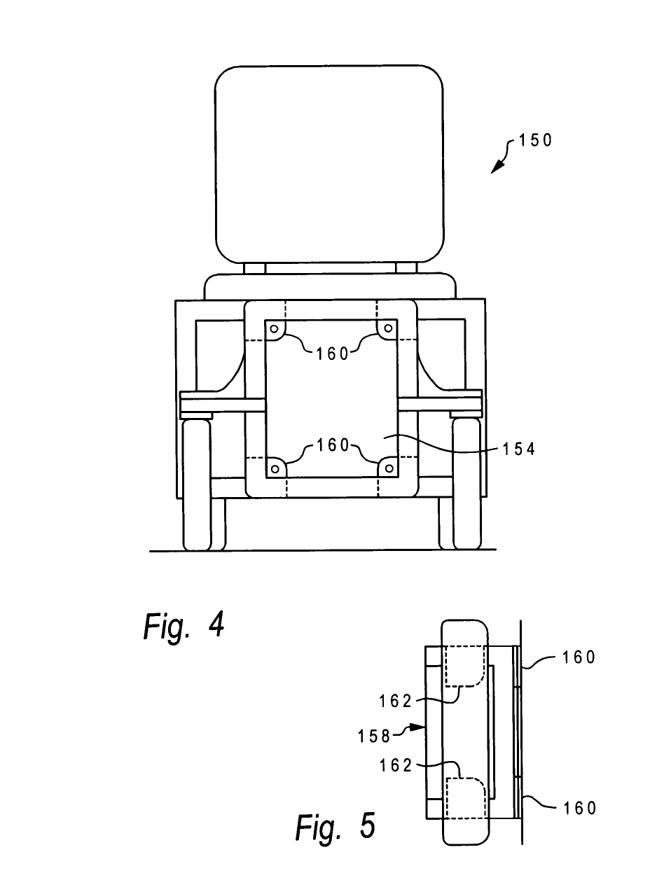

The mechanical interfaces 160, 162 consist of mounting pads that are permanently attached to structural members on the various module sub-frames. The mounting pads contain holes for locating pins and fasteners for securing the modules to one another. FIG. 4 illustrates first style interface 160 which has four such mounting pads located in the four corner of the generally rectangular front surface of center module 154. As noted above, the rear surface of center module 154 has an identical mounting interface, with four pads in the four corners. The terms “front surface” and “rear surface” are somewhat interchangeable when applied to center module 154 since that module is adapted for two different orientations in which the front and rear surfaces switch position. Rather than providing separate mounting pads, a single mounting plate can be used along one side of the module.

FIG. 5 illustrates second style interface 162 which is used to attach rear module 156 to seatback module 158. Two mounting pads are provided on opposite sides of the upper surface of rear module 156, and two matching pads are provided on opposite sides of the lower surface of seatback module 158.

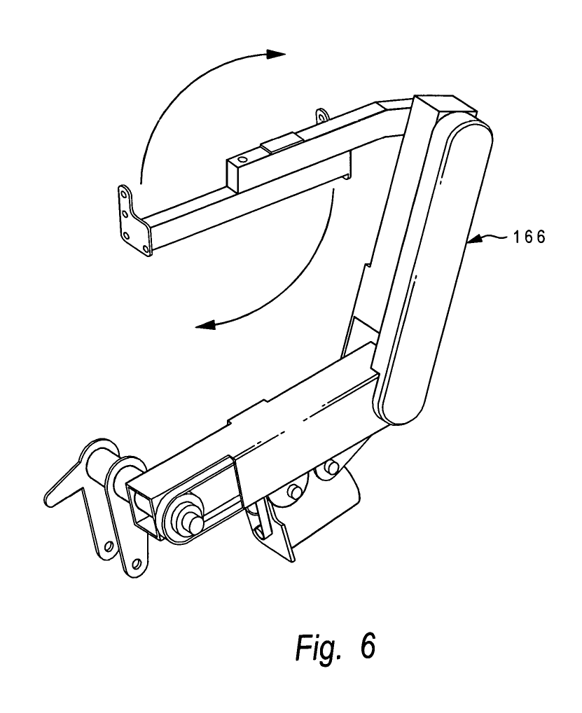

The lifting arm 166 for center lifting module 154′ is slightly different from the lifting arm shown in the embodiment of FIG. 1. As seen in FIG. 6, lifting arm 166 has one less link arm—link 36 is omitted from this design. For the embodiment shown in FIG. 1, link 36 was used only to vertically raise the lifting bridle to achieve sufficient clearance for transferring the user. For the embodiment of FIG. 3, the entire lifting arm 166 is instead raised (about seven inches) from its stowed position before the bridle is deployed, using the same drive motors.

FIG. 6 also illustrates how the lifting bridle can rotate horizontally to impart further versatility in the deployment of the lifting arm. By allowing the lifting bridle to rotate 180 degrees, the user can be facing a different direction other than forward. If modular mobility unit 150 is currently configured for only, say, left-handed deployment, it is still possible to transfer the user with other angular configurations with respect to the docking station.

Since the transverse centerline of operation of the lifting arm 166 for modular mobility unit 150 is equidistant between the front and rear mounting surfaces of module 154′, and since the front and rear mounting surfaces are identical (each utilizing first style interface 160), the center section of the chair can be assembled in one of two different orientations, so the arm can transfer its occupant equally well to the either the right side or to the left side. Thus, if an individual's living conditions or environment changes, and it is necessary to alter the handedness of the lift/transfer/elevate chair, this change can easily be implemented by a service technician. The electrical connections passing through the interfaces on the front and rear sides of the center section of the chair are first disconnected. Front module 152 is removed from the front mounting surface of center module 154. Rear module 156 is also disconnected from the rear mounting face of center module 154. Center module is then rotated 180 degrees so that the lifting arm operates from the opposite side of the chair. Front module 152 and rear module 156 are thereafter re-attached to the identical mounting interfaces on center module 154. The electrical connections within the chair are re-established, and the chair now functions as an opposite hand unit.

Similarly, modular mobility unit 150 can be assembled in a manufacturing facility for use as either right- or left-hand operation against any customer orders. This approach significantly reduces the amount of inventory of different parts required for the manufacturer to provide both right- and left-handed versions of the lift/transfer/elevate wheelchair, and decreases overall factory costs for the chair.

The versatility and functionality of the modular mobility unit enables one basic modular product platform to be configured as a large number of different individual products, each with specific capabilities and each upgradeable or field re-configurable to other products. These products can vary not only with regard to the handedness of the chair, but additionally with regard to the other features. For example, center module 154 could be replaced with an actuator module which does not even have a transfer mechanism (or docking station), but could still utilize some other lift, elevation, tilt or recline mechanism to provide the user with other accessibility options. These drive mechanisms can be mounted with a similar central sub-frame having the same first style interface 160. In an even simpler version, central module 154 could be replaced with a plain sub-frame having no lifting arm, docking stations, or seat-powering actuators.

Likewise, rear module 156 could be replaced with a module having no geared drive motors, but still having rear wheels, storage batteries, a lifting control computer, and wiring hub, all mounted on a sub-frame that has first style mounting interface 160 on its vertical side and second style mounting interface 162 on its upper surface.

Seatback module 158 can similarly be constructed with or without manual push handle bars, or a push-button operator interface for use by a caregiver in case the chair's occupant is unable to control its lift-transfer functions. An alternative rear module can provide the “powered push” handle bars to control the chair's propulsion.

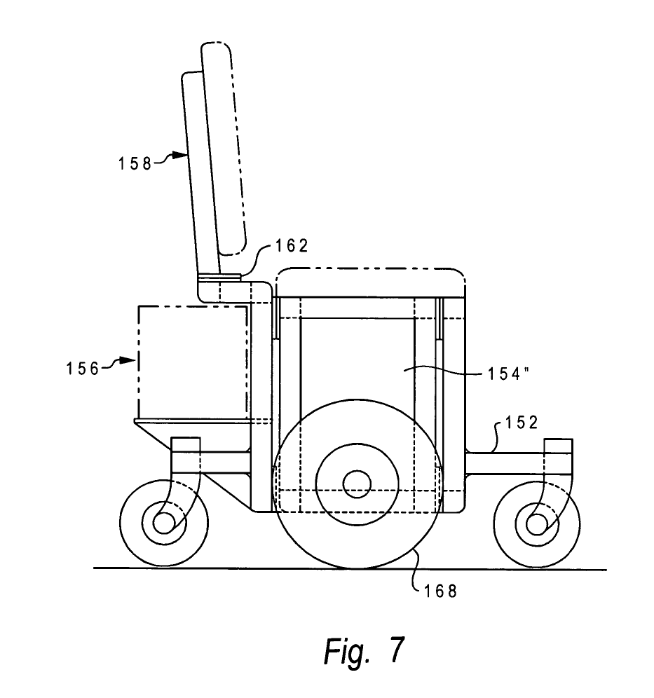

One example of the versatility in locating a particular function in a given module is shown in FIG. 7 which illustrates a center module 154″ having a propulsion mechanism. This “center drive module” 154″ may contain the power supply (battery), and has two drive wheels 168. Thus, the propulsion mechanism is not necessarily provided by either the front or rear modules 152, 156.

Multiple products can be derived from various combinations of these alternative features. The following eight embodiments are exemplary of the different products that can be configured using the four basic modules described above (these eight embodiments are not exclusive of all of the possible combinations):

A. Occupant-controlled powered wheel chair with powered lift and transfer functions and with lift module assembled for right-hand transfer;

B. Occupant-controlled powered wheel chair with powered lift and transfer functions and with lift module assembled for left-hand transfer;

C. Caregiver-controlled powered wheel chair with powered lift and transfer functions, with powered push function, and with lift module assembled for right-hand transfers;

D. Caregiver-controlled powered wheel chair with powered lift and transfer functions, with powered push function, and with lift module assembled for left-hand transfers;

E. Caregiver-controlled powered wheel chair with powered lift and transfer functions, but with manual push function (no drive motors), and with lift module assembled for right-hand transfers;

F. Caregiver-controlled powered wheel chair with powered lift and transfer functions, but with manual push function (no drive motors), and with lift module assembled for left-hand transfers.

G. Occupant-controlled standard powered wheel chair with joy stick control for propulsion drive motors, with no powered lift or transfer functions and no powered tilt or recline seating functions;

H. Occupant-controlled standard powered wheel chair with joy stick control for propulsion drive motors, with no powered lift or transfer functions but with built-in powered elevate, tilt or recline seating functions.

If the number of functions provided by the chair's modules were increased (beyond four), then the number of possible products or field upgrades can also be significantly increased.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. It is therefore contemplated that such modifications can be made without departing from the spirit or scope of the present invention as defined in the appended claims.

What is claimed is:

1. A method of assembling a mobility chair, comprising the steps of:
selecting at least one of a plurality of alternate modular components for the mobility chair; and
operably attaching the selected alternate modular component to a chassis of the chair.

2. The method of claim 1 wherein the alternate modular components include a plurality of modules having differing patient lift functions.

3. The method of claim 1 wherein the alternate modular components include a plurality of modules having differing propulsion functions.

4. The method of claim 1 wherein the alternate modular components include a plurality of modules having different electronic control functions.

5. The method of claim 1 wherein there are different sets of the plurality of modular components, a given set having a plurality of modules each of which is adapted to be positioned in a common location of the chair chassis and which provide different functions.

6. A method of assembling a mobility chair, comprising the steps of:
providing a lifting module which can function in either a right-hand orientation or a left-hand orientation;
orienting the lifting module with respect to a chassis of the mobility chair according to a desired handedness for the mobility chair; and
attaching the lifting module to the chair chassis with the desired handedness.

7. The method of claim 6 wherein said attaching step removably attaches the lifting module to the chair chassis.

8. The method of claim 6 wherein said orienting step orients the lifting module for right-handed use.

9. The method of claim 6 wherein said orienting step orients the lifting module for left-handed use.

10. The method of claim 6 further comprising the steps of:
removing the lifting module from the chair chassis;
re-orienting the lifting module according to an altered handedness for the mobility chair; and
re-attaching the lifting module to the chair chassis with the altered handedness.

11. A modular mobility unit comprising:
a chair frame; and
at least one module removably attached to said chair frame, said module being selected from the group consisting of a wheel module, a lifting module, a propulsion module, and a caregiver control module.

12. The modular mobility unit of claim 111 wherein the lifting module is a transferring module.

13. The modular mobility unit of claim 111 wherein the lifting module is a elevating module.

14. A modular mobility unit comprising:
a chair frame; and
at least two modules removably attached to said chair frame, said two modules being selected from the group consisting of wheel module, a lifting module, a propulsion module, and a seatback/caregiver control module.

15. The modular mobility unit of claim 14 wherein all four of said wheel module, lifting module, propulsion module, and seatback/caregiver control module are removably attached to said chair frame.

16. The modular mobility unit of claim 14 wherein said lifting module is adapted to function in either a right-hand orientation or a left-hand orientation.

17. A modular mobility unit comprising:
a chair frame;
a seat attached to said chair frame;
wheels operably mounted along a bottom of said chair frame; and
a center module removably attached to said chair frame.

18. The modular mobility unit of claim 17, further comprising a propulsion module removably attached to said chair frame for engaging at least one of said wheels.

19. The modular mobility unit of claim 17 wherein said center module includes a sub-frame having identical mounting interfaces on front and rear surfaces thereof.

20. The modular mobility unit of claim 19 further comprising front and rear modules each having a mounting interface for attachment to one of the mounting interfaces on said front and rear surfaces of said center module.

21. A transfer chair comprising:
a chair frame;
a seat attached to said chair frame;
wheels operably mounted along a bottom of said chair frame; and
a lifting module removably attached to said chair frame, said lifting module being adapted for attachment in either a right-hand orientation or a left-hand orientation.

22. The transfer chair of claim 21 wherein said lifting module has a lifting arm, said lifting arm being located along a transverse centerline of operation of said lifting module.

23. A transfer chair comprising:
a chair frame;
a seat attached to said chair frame;
wheels operably mounted along a bottom of said chair frame;
a lift and transfer arm pivotally attached to said chair frame; and
a lifting bridle attached to a distal end of said lift and transfer arm, said lifting bridle being horizontally rotatable to present a user at different directions with respect to the chair frame during a transfer.

24. The transfer chair of claim 23 wherein said lifting bridle can rotate up to 180 degrees.
